(19) United States
(12) Patent Application Publication
(10) Pub. No.: US 2023/0267721 A1
(43) Pub. Date: Aug. 24, 2023

(54) METHOD AND SYSTEM FOR TRAINING A MACHINE LEARNING MODEL FOR MEDICAL IMAGE CLASSIFICATION

(71) Applicant: VINBRAIN JOINT STOCK COMPANY, Ha Noi City (VN)

(72) Inventors: Ngoc Hoang NGUYEN, Ha Noi City (VN); Vu HOANG, Ha Noi City (VN); Huu Trung BUI, Ha Noi City (VN); Quoc Hung TRUONG, Ha Noi City (VN)

(21) Appl. No.: 17/965,093

(22) Filed: Oct. 13, 2022

(30) Foreign Application Priority Data
Feb. 24, 2022 (VN) 1-2022-01181

(51) Int. Cl. G06V 10/82; G06T 7/00; G06N 20/20

(52) U.S. Cl. CPC G06V 10/82; G06T 7/0012; G06N 20/20; G06T 2207/30061; G06T 2207/20081

(57) ABSTRACT

The present invention relates to a method and system for training a machine learning model for medical image classification. The method comprises providing a training dataset that comprises at least one training medical image, wherein the at least one training medical image is annotated with a ground-truth label; preprocessing the at least one training medical image to crop lung area in the at least one training medical image to generate a preprocessed training medical image; processing the preprocessed training medical image using an ensemble model according to ensemble parameters of the ensemble model to generate an ensemble prediction output; processing the preprocessed training medical image using the machine learning model according to machine learning parameters of the machine learning model to generate a machine learning prediction output, wherein the number of machine learning parameters is smaller the number of the ensemble parameters; minimizing a distillation loss that measures distance between the ensemble prediction output and the machine learning prediction output; and minimizing a machine learning loss that measures distance between the machine learning prediction output and the ground-truth label.

### TECHNICAL FIELD

The present invention generally relates to a method and system for training a machine learning model for medical image classification.

### BACKGROUND

Tuberculosis (TB) remains one of the most infectious diseases leading cause to worldwide death every year, which most often affects the lung known as pulmonary tuberculosis. According to the World Health Organization (WHO), patients from developing countries account for 95% of total TB patients in the world, where the healthcare system is still inadequate. Early diagnosis plays a critical role in improving treatment effectiveness and increasing patient survival rates. Applied CAD (computer-aided detection) method on X-ray diagnosis aids radiologists to interpret more accurately, reduce the overload problem of healthcare facilities in developing countries and help patients save waiting time and medical examination cost.

In conventional methods for TB classification, the CAD systems of TB classification have been developed using hand-crafted features extraction such as Gist, PHOG features with Support Vector Machine (SVM), Principal Component Analysis on statistical features from histogram images and features fusion. The weakness of those conventional methods is very sensitively to noisy input images due to various image quality, brightness, contrast.

According to the development of deep learning in many computer vision domains, CNNs have been proposed for TB diagnosis in the recent researches. In some previous approaches, pre-trained models of single typical CNNs such as VGG-16, VGG-19, RestNet50, GoogLenet, AlexNet, CapsNet, and their modified structure are used to identify TB manifested on X-ray images. Rajaraman et al. [1], [2], Guo et al. [3] presented an ensemble model method to improve the accuracy of single models. However, using ensemble models also significantly increases memory of the model's latency.

### CITATION LIST

### Non-Patent Literature

[1] S. Rajaraman and S. K. Antani, “Modality-specific deep learning model ensembles toward improving tb detection in chest radiographs,” IEEE Access, vol. 8, pp. 27318-27326,2020. The citation is herein referred to as [1].

[2] Rajaraman S, Kim I, and Antani S K, “Detection and visualization of abnormality in chest radiographs using modality-specific convolutional neural network ensembles,” PeerJ, vol. 8, pp. 8693, March 2020. The citation is herein referred to as [2].

[3] Ruihua Guo, Kalpdrum Passi, and Chakresh Kumar Jain, “Tuberculosis diagnostics and localization in chest x-rays via deep learning models,” Front Artif Intell, vol. 3, pp. 583427, October 2020. The citation is herein referred to as [3].

[4] J. Shiraishi, S. Katsuragawa, J. Ikezoe, T. Matsumoto, T. Kobayashi, K. Komatsu, M. Matsui, H. Fujita, Y. Kodera, and K. Doi, “Development of a digital image database for chest radiographs with and without a lung nodule: receiver operating characteristic analysis of radiologists' detection of pulmonary nodules,” American Journal of Roentgenology, vol. 174, pp. 71-74,2000. The citation is herein referred to as [4].

[5] Hanchao Li, Pengfei Xiong, Jie An, and Lingxue Wang, “Dual attention network for scene segmentation,” arXiv:1805.10180, 2018. The citation is herein referred to as [5].

[6] J. Fu et al, “Dual attention network for scene segmentation,” 2019 IEEE/CVF Conference on Computer Vision and Pattern Recognition (CVPR), pp. 3141-3149, 2019. The citation is herein referred to as [6].

[7] S. Jaeger, A. Karargyris, S. Candemir, L. Folio, J. Siegelman, F. Callaghan, Z. Xue, K. Palaniappan, R. K. Singh, S. Antani, G. Thoma, Y. X. Wang, P. X. Lu, and C. J. McDonald, “Automatic tuberculosis screening using chest radiographs,” IEEE Trans Med. Imaging, vol. 33(2), pp. 233-245, February 2014. The citation is herein referred to as [7].

[8] Arun Chauhan, Devesh Chauhan, and Chittaranjan Rout, “Role of gist and phog features in computer-aided diagnosis of tuberculosis without segmentation,” PloS One, vol. 9(11), 2014. The citation is herein referred to as [8].

[9] Y. Liu, Y. H. Wu, Y. Ban, H. Wang, and M. M. Cheng, “Rethinking computer-aided tuberculosis diagnosis,” 2020 IEEE/CVF Conference on Computer Vision and Pattern Recognition (CVPR), pp. 2643-2652, 2020. The citation is herein referred to as [9].

[10] Rajaraman S, Folio L R, Dimperio J, and Antani SK Alderson P O, “Improved semantic segmentation of tuberculosis-consistent findings in chest x-rays using augmented training of modality-specific u-net models with weak localizations,” Diagnostics, vol. 11(4), pp. 616, March 2021. The citation is herein referred to as [10].

[11] T. Rahman et al., “Reliable tuberculosis detection using chest x-ray with deep learning, segmentation and visualization,” IEEE Access, vol. 8, pp. 191586-191601, 2020. The citation is herein referred to as [11].

### SUMMARY

The invention has been made to solve the above-mentioned problems. An object of the invention is to provide a method and system for training a machine learning model for medical image classification. After being trained, the machine learning model is capable of classifying a chest X-ray image as a tuberculosis image or a non-tuberculosis image.

Problems to be solved in the embodiments are not limited thereto and include the following technical solutions and also objectives or effects understandable from the embodiments.

According to a first aspect of the invention, there is provided a method for training a machine learning model for medical image classification, the method comprising:

providing a training dataset that comprises at least one training medical image, wherein the at least one training medical image is annotated with a ground-truth label that is one of a tuberculosis label or a non-tuberculosis label;

preprocessing the at least one training medical image to crop lung area in the at least one training medical image to generate a preprocessed training medical image;

processing the preprocessed training medical image using an ensemble model according to ensemble parameters of the ensemble model to generate an ensemble prediction output, wherein the ensemble model has been trained on the training dataset such that the ensemble model is able to classify a medical image as a tuberculosis image or non-tuberculosis image;

processing the preprocessed training medical image using the machine learning model according to machine learning parameters of the machine learning model to generate a machine learning prediction output, wherein the number of machine learning parameters is smaller the number of the ensemble parameters;

minimizing a distillation loss that measures distance between the ensemble prediction output and the machine learning prediction output; and minimizing a machine learning loss that measures distance between the machine learning prediction output and the ground-truth label;

wherein the processing of the preprocessed training medical image using the ensemble model comprises:
setting the ensemble model to include a plurality of classification models;
processing the preprocessed training medical image using each of the plurality of classification models to generate a plurality of classification outputs; and
applying an ensemble algorithm to integrate the plurality of classification outputs into the ensemble prediction output.

According to a second aspect of the invention, there is provided a system for training a machine learning model for medical image classification, the system comprises one or more computers and one or more storage devices storing instructions that, when executed by the one or more computers, cause the one or more computers to perform the method according to the first aspect of the invention.

### BRIEF DESCRIPTION OF THE DRAWINGS

The above and other objects, features, and advantages of the present invention will become more apparent to those of ordinary skill in the art by describing in detail exemplary embodiments thereof with reference to the attached drawings, in which:

FIG. 1 is a block diagram showing an example system for training a machine learning model for medical image classification; and

FIG. 2 is a flow diagram of an example process for training a machine learning model for medical image classification using the example system of FIG. 1.

### DESCRIPTION OF EMBODIMENTS

While the invention may have various modifications and alternative forms, specific embodiments thereof are shown by way of example in the drawings and will be described herein in detail. However, there is no intent to limit the invention to the particular forms disclosed. On the contrary, the invention is to cover all modifications, equivalents, and alternatives falling within the spirit and scope of the appended claims.

It should be understood that, although the terms “first,” “second,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings, the same or corresponding components are denoted by the same reference numerals regardless of reference numbers, and thus the description thereof will not be repeated.

And throughout the detailed description and claims of the present disclosure, the term “training/trained” or “learning/learned” refers to performing machine learning through computing in accordance with a procedure. It will be appreciated by those skilled in the art that it is not intended to refer to a mental function such as human educational activity.

As used herein, a model is trained to output a predetermined output with respect to a predetermined input, and may include, for example, neural networks. A neural network refers to a recognition model that simulates a computation capability of a biological system using a large number of artificial neurons being connected to each other through edges.

The neural network uses artificial neurons configured by simplifying functions of biological neurons, and the artificial neurons may be connected to each other through edges having connection weights. The connection weights, parameters of the neural network, are predetermined values of the edges, and may also be referred to as connection strengths. The neural network may perform a cognitive function or a learning process of a human brain through the artificial neurons. The artificial neurons may also be referred to as nodes.

A neural network may include a plurality of layers. For example, the neural network may include an input layer, a hidden layer, and an output layer. The input layer may receive an input to be used to perform training and transmit the input to the hidden layer, and the output layer may generate an output of the neural network based on signals received from nodes of the hidden layer. The hidden layer may be disposed between the input layer and the output layer. The hidden layer may change training data received from the input layer to an easily predictable value. Nodes included in the input layer and the hidden layer may be connected to each other through edges having connection weights, and nodes included in the hidden layer and the output layer may also be connected to each other through edges having connection weights. The input layer, the hidden layer, and the output layer may respectively include a plurality of nodes.

Hereinafter, training a neural network refers to training parameters of the neural network. Further, a trained neural network refers to a neural network to which the trained parameters are applied.

Basically, the neural network may be trained through supervised learning or unsupervised learning. Supervised learning refers to a method of providing input data and label corresponding thereto to the neural network, while in unsupervised learning, the input data provided to the neural network does not contain label.

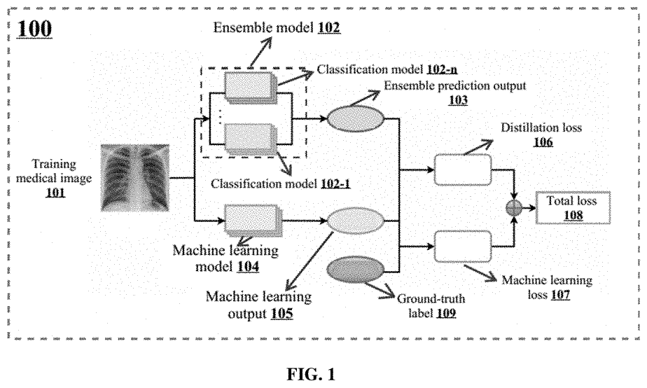

FIG. 1 is the block diagram showing an example system for training a machine learning model for medical image classification (hereinafter, the system 100). The system 100 is an example of a system implemented as computer programs on one or more computers in one or more locations in which the systems, components, and techniques described below are implemented. After being trained, the machine learning model 104 is capable of classify an input chest X-ray image as a tuberculosis image (i.e., positive image) or non- tuberculosis image (i.e., negative image).

To train the machine learning model 104, a training dataset is required to be set up. The training dataset comprises a plurality of medical images. According to a preferred embodiment, the medical images are chest X-ray images. Each medical image in the training dataset is labeled with a ground-truth label that is one of a tuberculosis label or a non-tuberculosis label.

The system 100 comprises an ensemble model 102 that comprises a plurality of classification model, namely a first classification model 102-1, . . . , a n-th classification model 102-n, the machine learning model 104. The system 100 further comprises a modified U-Net based module (not shown) that has been trained on collected data from Shenzhen dataset, Montgomery dataset, and JSRT dataset [4] to crop lung area in each medical images of the training database in order to eliminate confounding factors or unrelated parts such as bone or soft tissue to generate preprocessed training medical images.

The system trains the machine learning model 104 on the training dataset. As shown in FIG. 1, a training medical image 101 of the training dataset is illustrated as the training image that has been pre-processed so that only lung area is kept on the training image. The training medical image 101 is labeled with a ground-truth label that is one of a tuberculosis label or a non-tuberculosis label.

The ensemble model 102 processes the training medical image 101 according to ensemble parameters of the ensemble model 102 to generate an ensemble prediction output 103. The ensemble model 102 has been trained on the training dataset such that the ensemble model is able to classify a medical image as a tuberculosis image or non-tuberculosis image. In particular, each of the plurality of classification models of the ensemble model 102 processes the training medical image 101 to generate a corresponding classification output. For example, the first classification model 102-1 processes the training medical image 101 to generate a first classification output, . . . , the n-th classification model 102-n processes the training medical image 101 to generate a n-th classification output. Then, an ensemble algorithm is applied on the plurality of classification outputs (i.e., the first classification output, . . . , the n-th classification output) to integrate the same into the ensemble prediction output 103.

According to the preferred embodiment, the plurality of classification models are convolutional networks selected from Densenet121, Densenet169, Densenet201, Xception, ResNext-101, EfficientNet-B3, EfficientNet-B5. The plurality of classification models is further combined with attention neural networks such as FPA [5], SAM [6] to emphasis into important features to improve classification accuracy.

According to the preferred embodiment, the ensemble algorithm is selected from linear regression, voting, boosting, staking (e.g., AdaBoost, gradient boosting), and differential evolution.

The ensemble method significantly improves model quality, but it may take a cost and computation resource to deploy into the real-life production system. Therefore, the ensemble model 102 is used as a teacher model to distillate knowledge for a student model which is the machine learning model 104 of FIG. 1. In particular, the machine learning model 104 processes the training medical image 101 according to machine learning parameters of the machine learning model 104 to generate a machine learning prediction output 105. Since the machine learning model 104 play a student model role, the number of machine learning parameters is smaller the number of the ensemble parameters of the ensemble model 102. For example, the machine learning model 104 is based on EfficientNet-B5.

The system 100 minimizes a distillation loss 106 that is denoted as L_{kd} that measures distance between the ensemble prediction output 103 and the machine learning prediction output 105. According to the preferred embodiment, the distillation loss L_{kd} is a Kullback-Leibler divergence loss.

Furthermore, the system 100 minimizes a machine learning loss 107 that is denoted as Lₛₜ that measures distance between the machine learning prediction output 105 and the ground-truth label 109 of the training medical image 101. According to the preferred embodiment, the machine learning loss Lₛₜ is a binary cross-entropy loss.

As such, a total loss 108 that is denoted as L is used to train the machine learning model 104 is a weighted (λ) combination of the distillation loss L_{kd} and the machine learning loss Lₛₜ according to Equation 1 below.

Lₜₒₜₐₗ=Lₛₜ (pₛ, gₜ)+λ*L_{kd} (pₛ, pₜ), [Equation 1]

where pₛ, pₜ, gₜ is the logist of machine learning model 104, the ensemble model 102, and ground-truth label 109, respectively.

After being trained the machine learning model 104 is able to perform a medical image classification task in inference stage. In particular, the trained machine learning model 104 obtains a chest X-ray input image. Then, the trained machine learning model 104 processes the chest X-ray input image to generate an output label that is used to classify the input image as a tuberculosis image or a non-tuberculosis image.

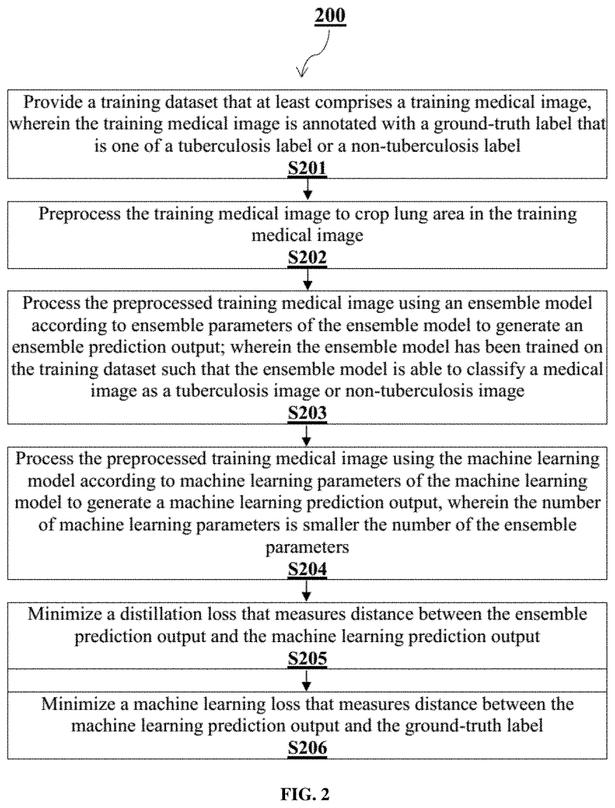

FIG. 2 is a flow diagram of an example process 200 for training a machine learning model for medical image classification. For convenience, the process 200 will be described as being performed by a system of one or more computers located in one or more locations. For example, a system for training a machine learning model for medical image classification, e.g., the system 100 for training a machine learning model for medical image classification (hereinafter referred to as “the system”) of FIG. 1, appropriately programmed, can perform the process 200.

In step S201, the system provides a training dataset that comprises at least one training medical image. The at least one training medical image is annotated with a ground-truth label that is one of a tuberculosis label or a non-tuberculosis label.

According to a preferred embodiment, the at least one training medical image is a chest X-ray image.

In step S202, the system preprocesses the at least one training medical image to crop lung area in the at least one training medical image to generate a preprocessed training medical image (for example, the training medical image 101 of FIG. 1).

In step S203, the system processes the preprocessed training medical image using an ensemble model (for example, the ensemble model 102 of FIG. 1) according to ensemble parameters of the ensemble model to generate an ensemble prediction output (for example, the ensemble prediction output 103 of FIG. 1). The ensemble model has been trained on the training dataset such that the ensemble model is able to classify a medical image as a tuberculosis image or non-tuberculosis image.

Step S203 comprises operations 1-3:

Operation 1: The system sets the ensemble model to include a plurality of classification models (for example, the first classification model 102-1, . . . the n-th classification model 102-n of FIG. 1).

Operation 2: The system processes the preprocessed training medical image using each of the plurality of classification models to generate a plurality of classification outputs.

Operation 3: The system applies an ensemble algorithm to integrate the plurality of classification outputs into the ensemble prediction output.

According to the preferred embodiment, the ensemble algorithm is selected from linear regression, voting, boosting, staking, and differential evolution.

In step S204, the system processes the preprocessed training medical image using the machine learning model (for example, the machine learning model 104 of FIG. 1) according to machine learning parameters of the machine learning model to generate a machine learning prediction output (for example, the machine learning output 105 of FIG. 1), wherein the number of machine learning parameters is smaller the number of the ensemble parameters.

According to the preferred embodiment, the machine learning model is based on EfficientNet-B5.

According to the preferred embodiment, the plurality of classification models are convolutional networks selected from Densenet121, Densenet169, Densenet201, Xception, ResNext-101, EfficientNet-B3, EfficientNet-B5.

According to the preferred embodiment, the plurality of classification models is further combined with attention neural networks to emphasis into important features.

In step S205, the system minimizes a distillation loss (for example, the distillation loss 106 of FIG. 1) that measures distance between the ensemble prediction output and the machine learning prediction output.

According to the preferred embodiment, the distillation loss is a Kullback-Leibler divergence loss.

In step S206, the system minimizes a machine learning loss (for example, the machine learning loss 107 of FIG. 1) that measures distance between the machine learning prediction output and the ground-truth label (for example, the ground-truth label 109 of FIG. 1).

According to the preferred embodiment, the machine learning loss is a binary cross-entropy loss.

The process 200 further comprises inference operations a) and b).

In operation a), the system receives a chest X-ray input image.

In operation b), the system processes the chest X-ray input image using the trained machine learning model to generate an output label that is used to classify the input image as a tuberculosis image or a non-tuberculosis image.

### EXPERIMENTS

In this section, the method of the invention is referred to as KD (Knowledge distillation) method.

### 1. Tuberculosis (TB) Datasets

The public TB dataset is limited caused by the medical records storage system in developing countries is still lacking, and data collection privacy is also quite tricky. In recent years, there are some public TB datasets have been introduced; their information is summarized in Table 1.

TABLE 1
Public TB dataset summarization. “#Non-TB” denotes number of
non-Tuberculosis images. “#TB” denotes number of Tuberculosis images.

| Dataset | Label | #Non-TB | #TB |
|---|---|---|---|
| Shenzhen TB [7] | Binary classification | 326 | 336 |
| Montgomery County TB[7] | Binary classification | 80 | 58 |
| DA&DB[8] | Binary classification | 153 | 153 |
| TBX11K[9] | Binary classification | 10,000 | 1,200 |
| | Detection (bounding box) | | |
| VB-TB of the | Binary classification | 228,827 | 17,389 |
| invention | Segmentation (pixel-level) | | |

### 2. TB Data Collection and Labeling Process

To build a large TB dataset to train deep learning models, the experiments collected more than 500,000 CXRs images (i.e., Chest X-ray images) from different locations in Vietnam, India, China, and well-known public datasets, namely, VB-TB dataset. With images taken from hospitals, the label is extracted from retrospective methodology. Otherwise, two independent senior radiologists with more than five years of experience label images taken from public sources. Disagreed images are reviewed again by an expert team of 3 other radiology experts. In labeling progress, the positive images are annotated for TB area segmentation.

For the classification task, the experiments split the VB-TB dataset into three subsets, which include training set (14,247 positive images and 216,900 negative images), validation set (1,086 positive images and 4,041 negative images), and test set (2,056 positive images and 7,886 negative images).

### 3. Experiment Results

The performance of different models is evaluated and compared on both VB-TB test set and public test set TBX11K dataset. The summarization of experiment results is presented in Table 2 and Table 3.

TABLE 2
Comparison of different models on VB-TB test set with metrics
like Accuracy, F1 score, Recall, Precision, Specificity

| Method | AUC | Acc. | F1. | Rec. | Pre. | Spec. |
|---|---|---|---|---|---|---|
| VGG-19 [10] | 97.2 | 92.1 | 82.6 | 88.7 | 77.3 | 93.1 |
| Staking ensemble model [1] | 98.4 | 93.7 | 85.7 | 89.9 | 81.8 | 94.7 |
| Densenet121 | 97.3 | 92.4 | 82.9 | 88.1 | 78.3 | 93.6 |
| Densenet169 | 97.6 | 92.9 | 83.9 | 88.5 | 79.7 | 94.0 |
| Densenet201 | 97.4 | 92.7 | 83.2 | 87.9 | 78.9 | 93.8 |
| Xception | 97.2 | 91.9 | 82.1 | 88.8 | 76.3 | 92.7 |
| ResNext-101 | 97.9 | 93.0 | 84.3 | 90.0 | 79.2 | 93.7 |
| EfficientNet-B3 | 97.2 | 92.1 | 82.3 | 88.1 | 76.2 | 93.1 |
| EfficientNet-B5-SAM | 98.1 | 93.3 | 85.0 | 91.9 | 79.9 | 93.9 |
| EfficientNet-B5-FPA | 98.1 | 93.4 | 85.1 | 90.7 | 80.2 | 94.1 |
| Ensemble model | 98.8 | 94.7 | 88.1 | 92.9 | 83.7 | 95.2 |
| EfficientNet-B5-FPA(KD) | 98.6 | 94.5 | 87.5 | 92.5 | 83.1 | 95.1 |

For TB classification tasks, the classification model is evaluated by different metrics such as AUC, accuracy, F1-score, recall (sensitivity), precision, and specificity. The ensemble model always achieved better accuracy than single models. The effectiveness of KD methods is proved in both Table 2 and Table 3. By applying KD methods, the experiments optimize the ensemble model of more than 278M parameters to the EfficientNet-B5-FPA model of 30M parameters, while model accuracy decreases only 0.6% on VB-TB test set and 0.4% on TBX11K dataset. While without using KD methods, single model EfficientNet-B5-FPA obtained 3%, and 2.9% lower than ensemble models. The model of invention also outperformed other exited approaches; the experiments achieved 92.5% sensitivity, 83.1% precision, 95.1% specificity on the VB-TB test set.

TABLE 3
Comparison of different models on TBX11K dataset.

| Method | AUC | Acc. | F1. | Rec. | Pre. | Spec. |
|---|---|---|---|---|---|---|
| VGG-19 [10] | 93.4 | 95.7 | 81.2 | 83.5 | 79.1 | 97.3 |
| Staking ensemble model [1] | 95.3 | 96.6 | 84.9 | 85.5 | 84.2 | 98.0 |
| CheXNet[11] | 93.8 | 95.9 | 81.7 | 82.5 | 80.9 | 97.6 |
| EfficientNet-B5-FPA | 94.9 | 96.5 | 84.4 | 85.5 | 83.4 | 97.9 |
| Ensemble models | 96.9 | 97.1 | 87.3 | 89.5 | 85.2 | 98.1 |
| EfficientNet-B5-FPA(KB) | 96.7 | 96.8 | 86.1 | 88.5 | 83.9 | 97.9 |

For a system of one or more computers to be configured to perform particular operations or actions means that the system has installed on it software, firmware, hardware, or a combination of them that in operation cause the system to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a relationship graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for training a machine learning model for medical image classification, comprising:
providing a training dataset that comprises at least one training medical image, wherein the at least one training medical image is annotated with a ground-truth label that is one of a tuberculosis label or a non-tuberculosis label;
preprocessing the at least one training medical image to crop lung area in the at least one training medical image to generate a preprocessed training medical image;
processing the preprocessed training medical image using an ensemble model according to ensemble parameters of the ensemble model to generate an ensemble prediction output, wherein the ensemble model has been trained on the training dataset such that the ensemble model is able to classify a medical image as a tuberculosis image or non-tuberculosis image;
processing the preprocessed training medical image using the machine learning model according to machine learning parameters of the machine learning model to generate a machine learning prediction output, wherein the number of machine learning parameters is smaller the number of the ensemble parameters;
minimizing a distillation loss that measures distance between the ensemble prediction output and the machine learning prediction output; and
minimizing a machine learning loss that measures distance between the machine learning prediction output and the ground-truth label;
wherein the processing of the preprocessed training medical image using the ensemble model comprises:
setting the ensemble model to include a plurality of classification models;
processing the preprocessed training medical image using each of the plurality of classification models to generate a plurality of classification outputs; and
applying an ensemble algorithm to integrate the plurality of classification outputs into the ensemble prediction output.

2. The method of claim 1, further comprising:
receiving a chest X-ray input image; and
processing the chest X-ray input image using the trained machine learning model to generate an output label that is used to classify the input image as a tuberculosis image or a non-tuberculosis image.

3. The method of claim 2, wherein the plurality of classification models are convolutional networks selected from Densenet121, Densenet169, Densenet201, Xception, ResNext-101, EfficientNet-B3, EfficientNet-B5.

4. The method of claim 3, wherein the plurality of classification models is further combined with attention neural networks to emphasis into important features.

5. The method of claim 4, wherein the ensemble algorithm is selected from linear regression, voting, boosting, staking, and differential evolution.

6. The method of claim 5, wherein the machine learning model is based on EfficientNet-B5.

7. The method of claim 6, wherein the distillation loss is a Kullback-Leibler divergence loss.

8. The method of claim 7, wherein the machine learning loss is a binary cross-entropy loss.

9. The method of claim 8, wherein the at least one training medical image is a chest X-ray image.

10. A system for training a machine learning model for medical image classification, the system comprising one or more computers and one or more storage devices storing instructions that, when executed by the one or more computers, cause the one or more computers to perform operations comprising:
providing a training dataset that comprises at least one training medical image, wherein the at least one training medical image is annotated with a ground-truth label that is one of a tuberculosis label or a non-tuberculosis label;
preprocessing the at least one training medical image to crop lung area in the at least one training medical image to generate a preprocessed training medical image;
processing the preprocessed training medical image using an ensemble model according to ensemble parameters of the ensemble model to generate an ensemble prediction output, wherein the ensemble model has been trained on the training dataset such that the ensemble model is able to classify a medical image as a tuberculosis image or non-tuberculosis image;
processing the preprocessed training medical image using the machine learning model according to machine learning parameters of the machine learning model to generate a machine learning prediction output, wherein the number of machine learning parameters is smaller the number of the ensemble parameters;
minimizing a distillation loss that measures distance between the ensemble prediction output and the machine learning prediction output; and
minimizing a machine learning loss that measures distance between the machine learning prediction output and the ground-truth label;
wherein the processing of the preprocessed training medical image using the ensemble model comprises:
setting the ensemble model to include a plurality of classification models;
processing the preprocessed training medical image using each of the plurality of classification models to generate a plurality of classification outputs; and
applying an ensemble algorithm to integrate the plurality of classification outputs into the ensemble prediction output.
